(19) United States
(12) Patent Application Publication
(10) Pub. No.: US 2026/0049193 A1
(43) Pub. Date: Feb. 19, 2026

(54) POLYMERIC NANOFOAM WITH TUNABLE CELL STRUCTURE AND METHOD FOR FABRICATING POLYMERIC NANOFOAM

(71) Applicant: National Taiwan University of Science and Technology, TAIPEI CITY (TW)

(72) Inventors: Shu-Kai YEH, Taipei City (TW); Kiday Fiseha GEBREMEDHIN, TAIPEI CITY (TW); Solomon Dufera TOLCHA, TAIPEI CITY (TW)

(21) Appl. No.: 18/943,980

(22) Filed: Nov. 12, 2024

(30) Foreign Application Priority Data
Aug. 19, 2024 (TW) 113131088

(51) Int. Cl. C08J 9/12

(52) U.S. Cl. CPC C08J 9/122; C08J 2201/032; C08J 2201/034; C08J 2203/06; C08J 2205/042; C08J 2333/12

(57) ABSTRACT

A polymeric nanofoam includes a plurality of nanocells, wherein the average diameter of the nanocells is less than 200 nm, and the number of nanocells is higher than 10¹³ cells/cm³. The polymeric nanofoam is formed of polymethyl methacrylate (PMMA) and has a flat area greater than 50 cm², a thickness greater than 5 mm, and a relative density less than 0.5. A method for fabricating the polymeric nanofoam is also disclosed herein.

### CROSS-REFERENCE TO RELATED APPLICATION

This application claims priority to Taiwan Application Serial Number 113131088, filed Aug. 19, 2024, which is herein incorporated by reference in its entirety.

### BACKGROUND

### Field of Invention

The present disclosure relates to polymeric foams having nano-scale cells and the related fabricating method.

### Description of Related Art

Polymeric foams have advantages such as low density, low thermal conductivity, good elasticity, and sound and heat insulation. Polymeric foams are widely used in various applications like soundproofing, thermal insulation, anti-freezing, shock absorption, etc. Nanofoam refers to the pores in the foam material reaching a nano-scale. U.S. Pat. No. 7,838,108 B2 discloses that if the cell size of polymeric foams reaches the nano-scale, the foams exhibit superstructure characteristics. This means that when the cell size is close to the nano-scale, the cells are smaller than the defects of the solid material itself, and then the material has physical properties close to those of the original solid. This theory has gained widespread recognition, and nanofoams have also sparked great interest in academia. One of the notable features of nanofoam materials is their thermal insulation properties. This is because the mean free path of gas molecules is approximately 100 nanometers. When gas molecules are confined within nano-scale cells, their movement is restricted, significantly reducing the thermal conduction effect caused by molecular collisions. This greatly decreases the loss of heat transfer. This phenomenon is called the Knudsen effect.

The formation of polymeric foams having nano-scale cells and the control of the properties of such polymeric foams will benefit many new applications.

### SUMMARY

Polymeric nanofoams have shown various outstanding performances; however, producing thick, large, and flat polymeric nanofoams remains challenging.

In view of such issue, some embodiments of the present disclosure provide nanofoams formed of polymethyl methacrylate (PMMA); the nanofoams have flat, thicker, and larger dimensions.

Some embodiments of the present disclosure provide a polymeric nanofoam including a plurality of nanocells, wherein the average diameter of the nanocells is less than 200 nm, and the number of the nanocells is higher than 10¹³ cells/cm³. The polymeric nanofoam is formed of PMMA, has a flat area greater than 50 cm², a thickness greater than 5 mm, and a relative density less than 0.5.

In some embodiments, in the polymeric nanofoam, the maximum deviation from the flat area is less than 1000 μm.

In some embodiments, the flat area of the polymeric nanofoam is smooth, and the average height deviations from the mean line of the flat area is less than 500 μm.

In some embodiments, the polymeric nanofoam is a homogeneous nanocellular type.

In some embodiments, the polymeric nanofoam is a homogeneous nanocellular type, and the relative density of the polymeric nanofoam ranges from about 0.23 to about 0.44.

In some embodiments, the polymeric nanofoam is a homogeneous nanocellular type, and the number of nanocells is higher than 10¹⁴ cells/cm³.

In some embodiments, the polymeric nanofoam is a homogeneous nanocellular type, and the coefficient of variation (CV) in size of the plurality of nanocells is less than 0.52.

In some embodiments, the polymeric nanofoam further includes a plurality of microcells, wherein the diameters of the microcells range from 1 μm to 100 μm, and the polymeric nanofoam is a bimodal cellular type.

In some embodiments, the polymeric nanofoam further includes ultra-microcells having diameters of 200 nm to 1 μm.

In some embodiments, the polymeric nanofoam is a bimodal cellular type, and a relative density of the polymeric nanofoam ranges from about 0.18 to about 0.4.

In some embodiments, the polymeric nanofoam is a bimodal cellular type, and the frequency relative to the surface (FRS) of the microcells ranges from about 10% to about 45%.

Some embodiments of the present disclosure provide a method for fabricating polymeric nanofoam, including: saturating a PMMA sheet with CO₂ to form a PMMA/gas mixture, wherein the CO₂ content in the PMMA/gas mixture is more than 25 wt %, and the weight of the PMMA sheet is 100 wt %; performing a depressurization on the PMMA/gas mixture; transferring the PMMA/gas mixture to a hot-press foaming machine; and foaming the PMMA/gas mixture at a temperature of 50° C. to 80° C. to form a polymeric nanofoam board, wherein the polymeric nanofoam board has a plurality of nanocells having an average diameter less than 200 nanometers, a flat area greater than 50 cm², a thickness greater than 5 mm, and a relative density less than 0.5.

In some embodiments, during the fabricating polymeric nanofoam, the PMMA/gas mixture is sandwiched between two porous metal plates instead of using a mold with a fixed height for limiting the thickness of the PMMA/gas mixture.

In some embodiments, the cellular structure type of the polymeric nanofoam board is controlled by adjusting saturation conditions of the PMMA/gas mixture or rheological properties of the PMMA sheet, and the cellular structure type is associated with a thermal conductivity of the polymeric nanofoam board.

In some embodiments, the viscosity at 1.25 s-1 shear rate of the PMMA sheet ranges from about 1×10⁴ Pa·s to 1×10⁵ Pa·s.

In some embodiments, the saturating a PMMA sheet with CO₂ to form the PMMA/gas mixture is performed under a first saturation condition, and the first saturation condition includes a first temperature ranging from 24° C. to 26° C. and a first saturation pressure ranging from 30 MPa to 32 MPa.

In some embodiments, the first saturation condition is performed for at least 18 hours.

In some embodiments, the saturating a PMMA sheet with CO₂ to form the PMMA/gas mixture is performed under a second saturation condition, and the second saturation condition includes a second temperature ranging from 0° C. to 2° C. and a second saturation pressure ranging from 19 MPa to 22 MPa.

In some embodiments, the second saturation condition is performed for at least 36 hours.

### BRIEF DESCRIPTION OF THE DRAWINGS

Aspects of the present disclosure are best understood from the following detailed description when read with the accompanying figures.

FIG. 1 shows the flow of a method for fabricating polymeric nanofoam in accordance with some embodiments.

FIG. 2 shows a schematic diagram of fabricating polymeric nanofoam by a hot-press method in accordance with some embodiments.

FIG. 3 shows the saturation conditions and the foaming conditions in the process for fabricating polymeric nanofoam in accordance with some embodiments.

FIG. 4A shows the CO₂ absorption amount in the PMMA sheets in accordance with an experimental example.

FIG. 4B shows the CO₂ absorption amount in the PMMA sheets in accordance with an experimental example.

FIG. 5A shows images of polymeric nanofoams at different scales in accordance with some experimental examples. These polymeric nanofoams were fabricated by mixing PMMA sheets having different molecular weights in different ratios and using saturation condition I and the hot-press method.

FIG. 5B shows the cell sizes and cell densities (i.e., the number of cells per cm³) for the nanofoams formed of different PMMA-H contents in accordance with the experimental examples of FIG. 5A.

FIG. 5C shows the relative densities for the nanofoams formed of different PMMA-H contents in accordance with the experimental examples of FIG. 5A.

FIG. 6A shows the image of a polymeric nanofoam formed with a PMMA-LH50 sample, saturation condition II-2, and a foaming temperature of 50° C. in accordance with an experimental example.

FIG. 6B shows the image of a polymeric nanofoam formed with a PMMA-LH50 sample, saturation condition II-2, and a foaming temperature of 60° C. in accordance with an experimental example.

FIG. 6C shows the image of a polymeric nanofoam formed with a PMMA-LH50 sample, saturation condition II-2, and a foaming temperature of 70° C. in accordance with an experimental example.

FIG. 6D shows the image of a polymeric nanofoam formed with a PMMA-LH50 sample, saturation condition II-2, and a foaming temperature of 80° C. in accordance with an experimental example.

FIG. 6E shows the relative densities for the nanofoams foamed at different foaming temperatures (T_{foam}) of the experimental examples in FIGS. 6A to 6D.

FIG. 7 shows images of polymeric nanofoams at different scales in accordance with some experimental examples. These polymeric nanofoams were fabricated by mixing PMMA sheets having different molecular weights in different ratios, using saturation condition II-2 and foaming with the hot-press method.

FIG. 8A shows the relative densities for the nanofoams formed of different PMMA-contents and in different saturation conditions.

FIG. 8B shows the FRSs of the nanocells smaller than 200 nm, ultra-microcells, and the microcells for the nanofoams formed of different PMMA-H contents. These nanofoams were fabricated using saturation condition II-2 and the hot-press method.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting.

Nanofoams, with their ultra-low thermal conductivity, high strength and stiffness, and optical transparency, have the potential to become lightweight, transparent, low thermal conductivity, or super-insulating materials for use in the construction industry, automotive industry, or other industries.

Some embodiments of the present disclosure provide polymeric nanofoams formed of PMMA. Previously, the structures of nanofoams formed of PMMA were mostly granular or bead-like, or thin sheets (e.g., no more than 3 mm in thickness), or small curved sheets formed by the thermal bath method. However, such structures limit the application of polymeric nanofoams. Due to the small sample sizes, it is difficult to conduct some performance tests on polymeric nanofoams, such as tests related to thermal conductivity or mechanical properties. For example, the measurements of the thermal conductivity for polymeric nanofoams, limited by the sample sizes, are usually conducted using transient methods instead of the more accurate steady-state methods (e.g., steady-state plate method).

However, it is still challenging to produce large, thick, and flat polymeric nanofoams. For example, problems such as heat conduction, uneven stress, or the like within the material during foaming must be overcome. In the process of polymer foaming, the homogeneous system formed by the polymer and the foaming agent gas undergoes a complex phase transition process. During foaming, the foaming agent gas nucleates and grows from the polymer matrix, phase-separates with the polymer, forming a uniform and dense cell structure; on the other hand, the polymer undergoes phase transitions such as crystallization and vitrification under changing environmental temperatures, and under the influence of the foaming agent gas, ultimately forming a metastable molecular chain aggregation structure different from the conventional polymer molding process. It is challenging to control the formation of thick and flat foamed materials having uniformly distributed nano-scale cells and a high number of cells per unit volume.

As used herein, a “nano-scale” cell refers to the cell diameter is less than 200 nm; an “Ultra-micro-scale” cells refer to the cell diameter ranges from 200 nm to 1 μm; a “Micro-scale” cell refers the cell diameter greater than 1 μm.

As used herein, “relative density” refers to the ratio of the density of the polymeric nanofoam to the density of the non-foamed polymer material. “Cell density” refers to the number of cells that can be generated per cubic centimeter of an unfoamed polymer.

As used herein, a frequency relative to surface (FRS) refers to the percentage of the total area occupied by the cells of a certain size in a cross-section. The calculation of FRS can be represented by the following formula 1:

$$FRS \% = \frac{{n}_{cells , x} {π ( \frac{x}{2} )}^{2}}{{\sum }_{{x}_{i}} {n}_{cells , {x}_{i}} {π ( \frac{{x}_{i}}{2} )}^{2}} \times 100 \% \qquad ( 1 )$$

where n_{cells,x} represents the number of cells, and x represents the cell diameter.

In some embodiments of the present disclosure, the glass transition temperature of the polymer/gas mixture is fine-tuned by controlling the saturation temperature, pressure, and molecular weight distribution of the matrix. The hot-press foaming method is also used to obtain nanofoams having larger thickness and flat surfaces, i.e., nanofoam boards. In some embodiments, nanofoams having different cell structures can be obtained by controlling the saturation conditions and mixing the PMMA sheets having different molecular weights. In some embodiments, the sample is sandwiched between two air-permeable platesduring the hot-press foaming method, allowing the gas to diffuse gently. This results in nanofoams having flat and smooth surfaces.

In embodiments of the present disclosure, each of the polymeric nanofoams has a thickness of more than 5 mm and a flat area of more than 50 cm². The thickness of the polymeric nanofoam may be, for example, 5 mm to 10 mm, such as 5.5 mm, 6 mm, 6.5 mm, 7 mm, 7.5 mm, 8 mm, 8.5 mm, 9 mm, or 10 mm, or the like. In some embodiments, thicker polymeric nanofoams may also be achieved by controlling parameters such as the thickness of the raw material, saturation conditions, the fabrication dimensions of the hot-press foaming machine, or the like. The flat area of the polymeric nanofoam may be, for example, from about 50 cm² to about 100 cm², such as 50 cm², 60 cm², 70 cm², 80 cm², 90 cm², 100 cm², or the like. In some embodiments, larger flat polymeric nanofoams can be achieved by controlling parameters such as the size of the raw material, saturation conditions, the fabrication dimensions of the hot-press foaming machine, or the like. In some embodiments, larger polymeric nanofoams can be produced by increasing the volume of the reactor and the surface area of the molding machine.

In some embodiments, the polymeric nanofoam is a flat structure without warping, for example, the maximum deviation from the flat area is less than 1000 μm. In some embodiments, the surfaces of the polymeric nanofoam are smooth, without cracks or bubble-like texture. In some embodiments, the surface roughness of the flat area, defined as the average height deviations from the mean line of the flat area of the polymeric nanofoam, is less than 500 μm.

In embodiments of the present disclosure, the polymeric nanofoam has cells with an average diameter of less than 200 nanometers, i.e., nanocells, and the number of nanocells is higher than 10¹³ cells/cm³, higher than 10¹⁴ cells/cm³, or higher than 10¹⁵ cells/cm³. In embodiments of the present disclosure, the size distribution of cells in the polymeric nanofoam can be classified as either a homogeneous nanocellular type or a bimodal cellular type. In the homogeneous nanocellular type, the cells in the polymeric nanofoam are all or almost all nano-scale cells. In the bimodal cellular type, the cells in the polymeric nanofoam comprise both nano-scale cells (i.e., nanocells) and micro-scale cells (i.e., microcells). The bimodal cellular type of foam refers to a foamed material comprises two different size distributions of cells. Compared to the homogeneous nanocellular type of foam having a single size distribution of cells, the bimodal cellular type of foam can have higher porosity and lower thermal conductivity.

Embodiments of the present disclosure provide polymeric nanofoams which can be used for thermal insulation materials, and the thermal conductivity of the polymeric nanofoams can be tuned by controlling the distribution of cell sizes.

One characteristic for polymeric nanofoam is its high relative density as the nanocells limit foam density reduction. As the relative density of foam increases, the solid content increases, and the proportion of solid heat transfer also increases. Since the thermal conductivity of PMMA is almost ten times that of air, reducing foam density or increasing void fraction is essential to lower the thermal conductivity of foams. Therefore, in some embodiments of the present disclosure, introducing some micron-sized cells into the polymeric nanofoam can increase the porosity of the nanofoam, reduce the relative density of the nanofoam, and thus reduce the thermal conductivity of the nanofoam without significantly affecting the performance of the nanofoam. In some embodiments of the present disclosure, the cell size distribution and uniformity can be tuned by controlling the composition of the blend of PMMA sheets and the saturation conditions.

In some embodiments, in the polymeric nanofoam of the homogeneous nanocellular type, the number of nanocells is higher than 10¹⁴ cells/cm³. The coefficient of variation of the nanocell sizes is less than 0.52, such as ranging from about 0.42 to 0.52. In addition, the relative density of the polymeric nanofoam is 0.23 to 0.44, and the relative density of the formed polymeric nanofoam can be tuned by controlling the molecular weights of the PMMA sheets (e.g., by blending PMMA pellets having different molecular weights).

In some embodiments, in the bimodal cellular type of polymeric nanofoam, the frequency relative to surface (FRS) of microcells ranges from about 10% to about 45%, such as 10%, 15%, 20%, 25%, 30%, 35%, 40%, 45%, etc. In addition, the polymeric nanofoam has a lower relative density, such as a relative density of about 0.18 to 0.45, such as 0.18, 0.2, 0.23, 0.25, 0.28, 0.30, 0.32, 0.35, 0.38, 0.4, 0.42, 0.45, etc.

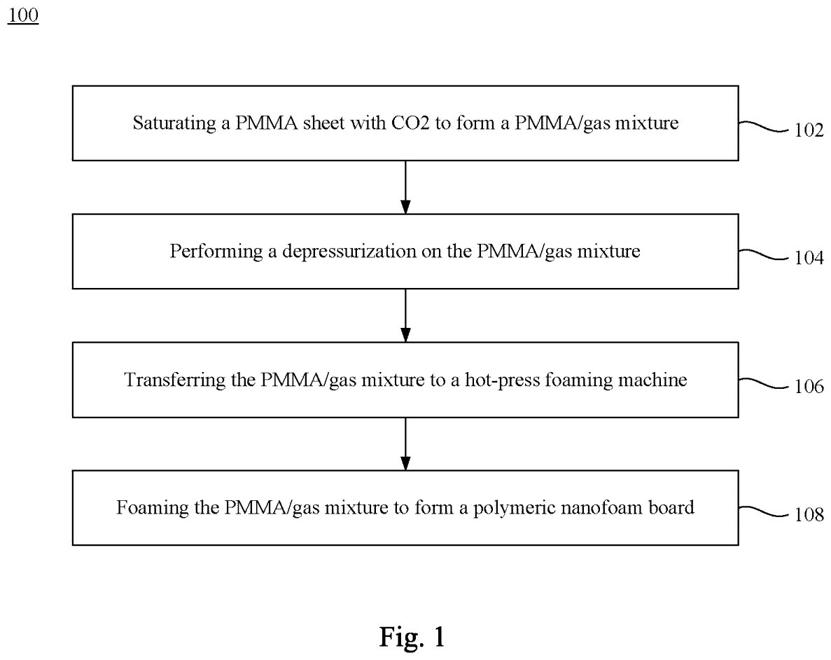

In other embodiments, the polymeric nanofoam further includes ultra-microcells having an average diameter from 200 nm to 1 μm. In some embodiments, ultra-microcells, which sizes ranging between nanocells and microcells, are quantified. As shown in Table 2, in foam sample No. 4, the FRSs (%) of the nano/ultra-micron/micron cells are 25/75/0; in foam sample No. 5, the FRSs (%) of the nano/ultra-micron/micron cells are 56/31/13; and in foam sample No. 6, the FRSs (%) of the nano/ultra-micron/micron cells are 68/19/13. Refer to FIG. 1, which shows the method of fabricating polymeric nanofoam according to some embodiments.

In step 102 of method 100, the PMMA sheet is immersed in carbon dioxide until saturation to form a PMMA/gas mixture. In some embodiments, the PMMA sheet is placed in a high-pressure tank containing CO₂. In some embodiments, before the subsequent foaming, the CO₂ content in the PMMA/gas mixture is greater than 25 wt %, such as 25 wt %, 30 wt %, 35 wt %, etc.

In some embodiments, different cellular types of foams are formed using PMMA sheets having different rheological properties and saturation conditions. The rheological properties of PMMA significantly affect cell growth rate, cell size, cell density, and relative density. In some embodiments, the viscosity at 1.25 s⁻¹ shear rate of the PMMA sheet ranges from about 1×10⁴ Pa·s to 1×10⁵ Pa·s. In some embodiments, the rheological properties of the PMMA sheet to be foamed can be adjusted by blending PMMA pellets having different molecular weights.

In some embodiments, the thickness of the PMMA sheet used is greater than 3 mm, such as from 3 mm to 6 mm, for example, 3.5 mm, 4 mm, 5 mm, 6 mm, or the like. The length and width dimensions of the PMMA sheet used may be at least 4 cm to 7 cm. The area size of the PMMA sheet can be adjusted depending on the size of the mold used in the hot-press foaming machine.

In some embodiments, different saturation conditions are used to form polymeric nanofoams having different cellular types.

In some embodiments, the homogeneous nanocellular type of polymeric nanofoam is formed under the first saturation condition. The first saturation condition includes a higher saturation temperature (Tₛₐₜ) and a higher CO₂ solubility. In some embodiments, when the PMMA sheet is immersed in carbon dioxide, the Tₛₐₜ temperature is set at 24° C. to 26° C., such as 25° C., and the saturation pressure is set at 30 MPa to 32 MPa, such as 31.03 MPa. In some embodiments, the first saturation condition is performed for at least 18 hours, such as 18 hours to 24 hours, to fully saturate the PMMA sheet with CO₂.

In some embodiments, a second saturation condition is used to form the bimodal cellular type of polymeric nanofoam. The second saturation condition includes a lower saturation temperature (Tₛₐₜ) and a higher CO₂ solubility. In some embodiments, when the PMMA sheet is immersed in carbon dioxide, the Tₛₐₜ temperature is set at 0° C. to 2° C., and the saturation pressure is set at 19 MPa to 22 MPa, such as 20.68 MPa. In some embodiments, the second saturation condition is performed for at least 36 hours, such as 36 hours to 72 hours, to fully saturate the PMMA sheet with CO₂.

Moreover, in some embodiments, the PMMA sheet can be optionally dried before step 102. For example, the PMMA sheet to be foamed, which is a blend of PMMA pellets having different molecular weights, is placed in an oven to dry. More specifically, the PMMA sheet to be foamed can be dried in an oven at a higher temperature for several hours to remove the moisture, thereby reducing the impacts of moisture. In other embodiments, step 102 can be performed directly.

In step 104 of method 100, performing a depressurization on the PMMA/gas mixture. In some embodiments, when the predetermined saturation time is reached, the high-pressure tank is depressurized, and then the CO₂-saturated PMMA/gas mixture is removed from the high-pressure tank.

In step 106 of method 100, the PMMA/gas mixture is transferred to a hot-press foaming machine.

In some embodiments, during the hot-pressing foaming of the PMMA/gas mixture, the PMMA/gas mixture is sandwiched between two porous metal plates without using a mold with a fixed height for limiting the thickness of the PMMA/gas mixture. Because the porous metal plates are air-permeable, the CO₂ gas can gently escape from the pores during foaming, to create polymeric nanofoam having smooth surfaces. Previously, PTFE (Polytetrafluoroethylene)/glass fiber composite was applied to sandwich the samples, allowing the gas to escape and prevent blistering during the hot-press foaming. However, the texture of the composite was imprinted on the sample's surface, and further polishing was necessary to remove the texture. In contrast, in embodiments of the present disclosure, the porous metal plates are used to prevent CO₂ from suddenly diffusing and escaping, so that the flatness and smoothness of the surfaces of the formed polymeric nanofoam can be improved.

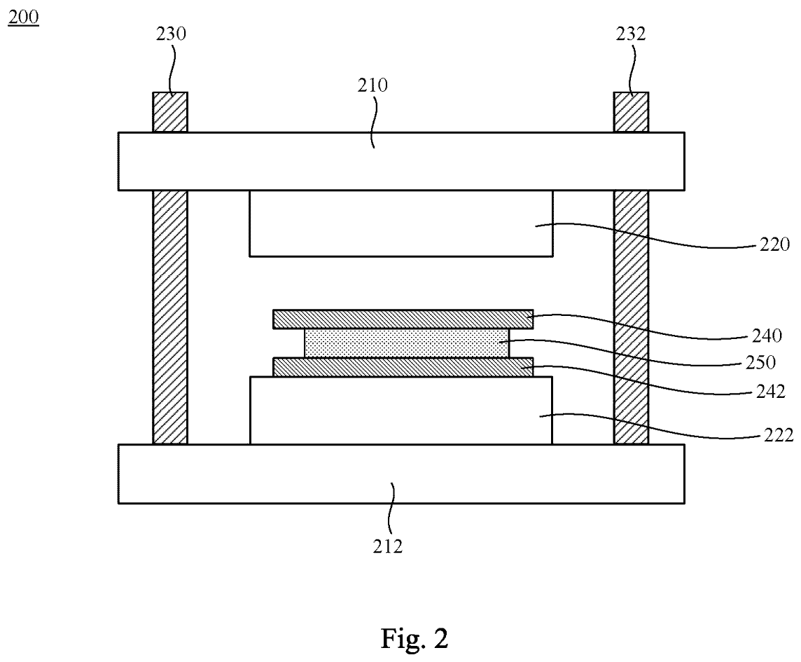

FIG. 2 shows a schematic diagram of foaming in a hot-press foaming machine according to some embodiments. The hot-press foaming machine 200 includes an upper structural plate 210 and a lower structural plate 212, an upper pressing plate 220 attached to the upper structural plate 210, a lower pressing plate 222 attached to the lower structural plate 212, and guide rods 230 and 232 disposed on both sides. During hot-press foaming, the PMMA/gas mixture 250 is sandwiched between two porous metal plates 240 and 242. In some embodiments, the porous metal plates 240 and 242 have a pore size of 0.2 μm to 1 μm, such as 0.5 μm. In some embodiments, the pore density of the porous metal plate used is greater than about 1×10¹² pores/cm³, for example, the pore density may be 1×10¹² pores/cm³, 5×10¹² pores/cm³, 1.5×10¹³ pores/cm³, or 5×10¹³ pores/cm³, etc. In some embodiments, the thickness of the porous metal plates 240 and 242 may be, for example, 3 mm to 10 mm. In the conventional hot-press method for forming polymeric foams, a fixed spacer is used to maintain the thickness of the sample. In contrast, in embodiments of the present disclosure, since the polymer/gas mixture's T_{g} will increase to above T_{foam} and solidify, foaming without a spacer may not significantly decrease the sample thickness but may increase the sample area, which is one of the purposes of the embodiments of the present disclosure. Therefore, before the foaming sample solidifies, the distance between the two porous metal plates is not fixed. That is, the foaming step is performed in a constant load system, and during the foaming process, the thickness of the foam increases, and the pressure/load remains unchanged.

In some embodiments, optionally, before foaming, the PMMA/gas mixture is held under an atmospheric condition for about 20 seconds to about 140 seconds, such as 60 seconds. Since the time period from depressurization to foaming may affect cell formation, in some embodiments, to ensure process consistency, the time is controlled to 60 seconds.

In step 108 of method 100, the PMMA/gas mixture is foamed to form a polymeric nanofoam board and then quenched under ice/water mixture to stabilize the cell structure.

In some embodiments, the PMMA/gas mixture is foamed at a foaming temperature (T_{foam}) of 50° C. to 80° C., so that the formed polymeric nanofoam board has nano-scale cells. The foaming temperature may be, for example, 50° C., 55° C., 60° C., 65° C., 70° C., 75° C., or 80° C.

To verify that the polymeric nanofoams produced by the aforementioned method indeed possess characteristics such as greater thickness, high nano-cell density, flat region, or the like, experimental examples are provided below. The parameters and data results of the following experimental examples are only to illustrate the polymeric nanofoams of the embodiments of the present disclosure and are not intended to limit the scope of the present disclosure.

### Materials and Preparation of PMMA Sheets

In experimental examples of the present disclosure, two grades of PMMA pellets, CM-205 and CM-211, purchased from Chi Mei Corporation, were used as raw materials. CM-205 is a high molecular weight PMMA (with molecular weight of 81 kg/mol), hence referred to as PMMA-H; CM-211 is a low molecular weight PMMA (with molecular weight of 58 kg/mol), hence referred to as PMMA-L. The density of the PMMA pellet was 1.19 g/cm³. The glass transition temperature (T_{g}) was 116° C., measured by Differential scanning calorimetry (DSC) at a heating rate of 10° C./min.

The PMMA-L and PMMA-H pellets were blended using an extruder. The screw size of the extruder is 32 mm. The hopper-to-die temperatures were set at 200 to 220° C. The screw speed was fixed at 150 rpm. The number following the sample name of PMMA-LH in the matrix indicates the weight percentage of PMMA-H in the blend. For example, a sample coded as “PMMA-LH40” represents 40 wt % of PMMA-H and 60 wt % of PMMA-L. The rheological properties of PMMA-LH blends were measured using a rheometer.

The PMMA-LH pellets were oven-dried at 80° C. for 12 h to remove moisture and molded using a compression molding machine. The temperatures of the upper and lower plates were set at 200° C. The plates were pre-heated under a pressure of 98 kPa and gradually increased to 2.94 MPa within 3 mins. The pressure was maintained for another 3 minutes. The sample was cooled down at ambient temperature.

In the experimental examples, the size of the precursor size for hot-press foaming was 48×48×4 mm³. Carbon dioxide was used as the foaming agent for the solid-state foaming experiments.

### Foaming Process of PMMA Sheets

The 4 mm thick PMMA sheet was oven-dried at 80° C. overnight before saturation. Then, the sheet was put in a one-liter high-pressure reactor. The reactor was pressurized to the pre-designed saturation pressure (Pₛₐₜ). The saturation temperature (Tₛₐₜ) was controlled using a recirculating chiller, and the reactor was cooled using a copper tube heat exchanger. When the saturation time (Tₛₐₜ) was reached, the pressure was released instantly to create thermodynamic instability. The supersaturated sample was removed from the reactor and kept at atmospheric conditions for a period of time before transferring to the hot-press foaming machine. The sample was held under atmospheric conditions for one minute before foaming to ensure process consistency.

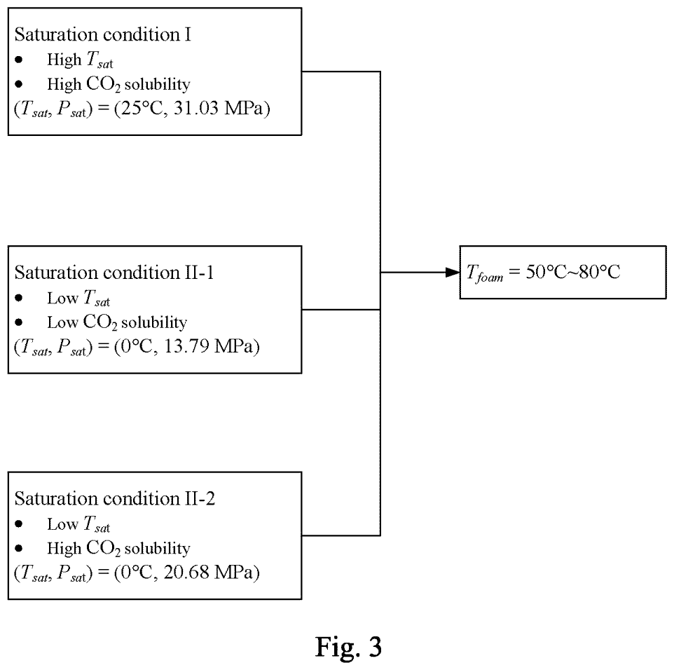

As shown in FIG. 3, the samples were foamed under two types of saturation conditions. In Saturation Condition I, the samples were saturated at 25° C. and 31.03 MPa to create an elevated CO₂ solubility and generate nanocellular foams with cell sizes around 200 nm. Following one-minute desorption, the samples were post-foamed at a foaming temperature (T_{foam}) of 50, 60, 70, or 80° C. for 3 minutes. In Saturation Condition II, the same materials were saturated at temperature of 0° C. and pressures of 13.79 MPa and 20.68 MPa. The low temperature and the lower pressure Saturation Condition II-1 were designed to generate a lower CO₂ solubility. The low temperature and elevated pressures of Saturation Condition II-2 were designed to generate high CO₂ solubility. The foaming processes were carried out at 50, 60, 70, or 80° C. for 3 minutes. In some examples, foaming temperatures between 50° C. and 80° C. were chosen to produce nanocellular foams having a relative density below 0.25.

The hot-press foaming method is shown in FIG. 2. The porous titanium alloy/316L stainless steel plates sold from ExtreMem, Inc, with a pore size of 0.5 μm and a pore density of 1.5×10¹³ pores/cm³, were used instead of PTFE/glass fiber composite materials. During the foaming process, gas can escape through the pores, resulting in smooth surfaces of the polymeric nanofoam board. The saturated sample was sandwiched by pre-heated porous metal plates at a pressure of 19.6 kPa for 3 mins. The foamed sample was immediately quenched in an ice-water mixture to stabilize the cell structure.

### Measurement of CO₂ Solubility

The saturated sample was removed from the high-pressure reactor and immediately placed on a Shimadzu AUX 220 analytical balance with an accuracy of ±0.1 mg to measure the amount of CO₂ absorbed. The sample weight was plotted against the square root of time and extrapolated to time zero to determine the CO₂ solubility. The CO₂ solubility was calculated using the following formula 2.

$${CO}_{2} Solubility ( wt \% ) = \frac{{W}_{{CO}_{2}}}{{W}_{PMMA}} \times 100 \% \qquad ( 2 )$$

Where W_{PMMa}, and W_{CO}_{₂} represent weights of PMMA sheet and of dissolved CO₂ at time equal to zero, respectively.

### Cell Structure Characterization

The foamed samples were cryo-fractured using liquid nitrogen for SEM imaging. The samples were sputter-coated with platinum. The cell structure was observed using a field emission SEM (JEOL 7900F). The cell structure was analyzed using ImageJ software. The cell density was calculated using the following formula 3:

$${N}_{0} = {( \frac{n}{A} )}^{\frac{3}{2}} ( \frac{{ρ}_{s}}{{ρ}_{f}} ) \qquad ( 3 )$$

where A, n, and No are the micrograph area (cm²), the number of cells in the micrograph, and the cell density (cells/cm³). The ρₛ and ρₜ are the solid and foam densities of materials in g/cm³, respectively. The foam density was measured after solid skin removal. The foam density was measured after solid skin removal.

### Thermal Conductivity Measurement

The thermal conductivity of the samples was measured using the TA instrument Fox 200 heat flow meter based on the steady-state method. According to the user's manual, the sample area must be larger than 100 mm×100 mm. The samples must be flat for accurate thermal conductivity measurement, ensuring they are leveled with the two isothermal plates. Before measuring the thermal conductivity, the edges and the skin of the sample were cut with a cutting machine. 1˜2 mm was removed from each side of the sample to investigate the properties of the nanocellular core. The samples were attached using double-sided tape to form a piece with area of 100 mm×100 mm for thermal conductivity measurement. Its thickness was 3.5-4 mm.

### Results and Discussion of the Experimental Examples

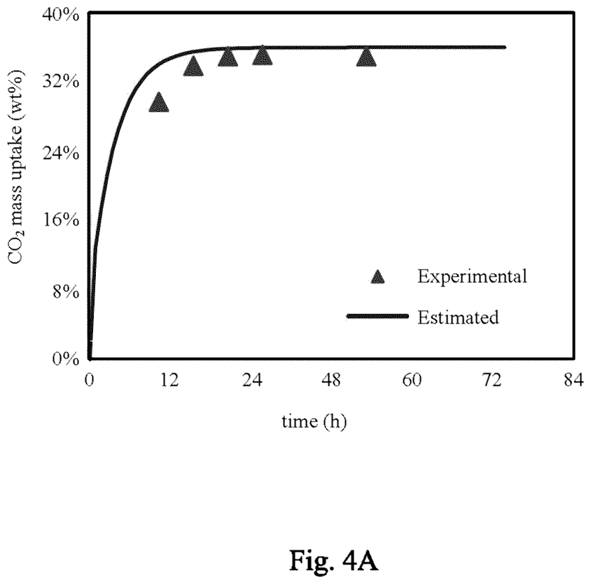

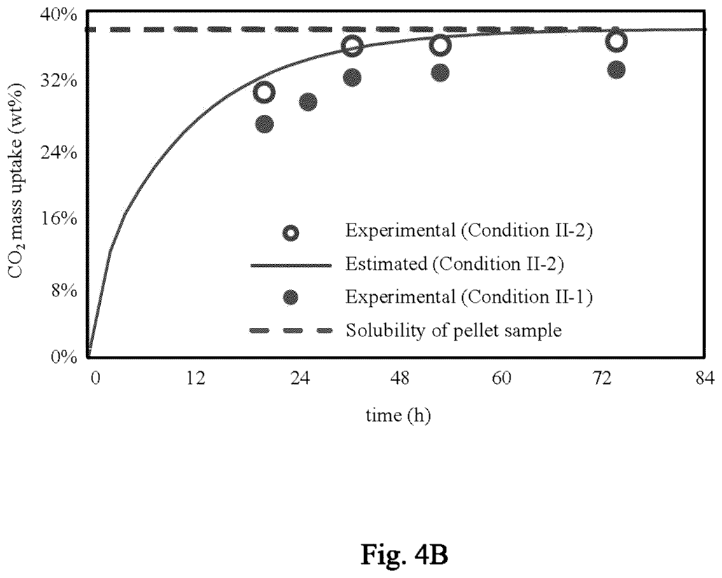

The amount of dissolved CO₂ determines the cell size, cell nucleation density, and relative density. It takes considerable time to saturate the sample at low temperatures, and the time needed to reach equilibrium CO₂ solubility under a given condition should be estimated beforehand. FIG. 4A shows the CO₂ solubility of the PMMA sheets under saturation condition I. It shows the CO₂ mass uptake versus time of samples saturated at 25° C. and 31.03 MPa, while the curved line shows the theoretical estimation. The sample was saturated after soaking for 18 hours, and in some experimental examples, the sample was saturated for 24 hours to ensure complete saturation. The CO₂ solubility was 35 wt %. FIG. 4A shows that that the experimental data and the simulated data fit well.

FIG. 4B shows the CO₂ mass uptakes of the samples in the saturation Condition II-1 and II-2. The experimental data points of saturation condition II-1 are lower than the estimated values. The dashed line in FIG. 4B represents the solubility of the particulate sample in previous literature under saturation condition II-1, which is 38 wt %. Under saturation condition II-2, when Pₛₐₜ was increased to 20.68 MPa, the solubility increased to 36 wt %, and the sample was saturated after 36 hours.

Cell Structure with Saturation Condition I

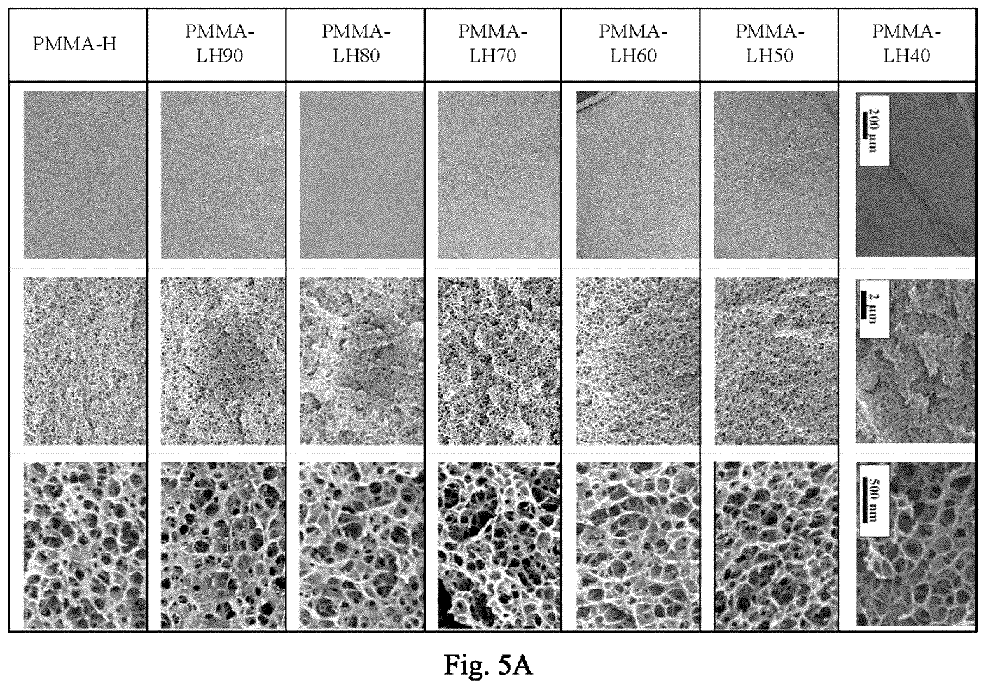

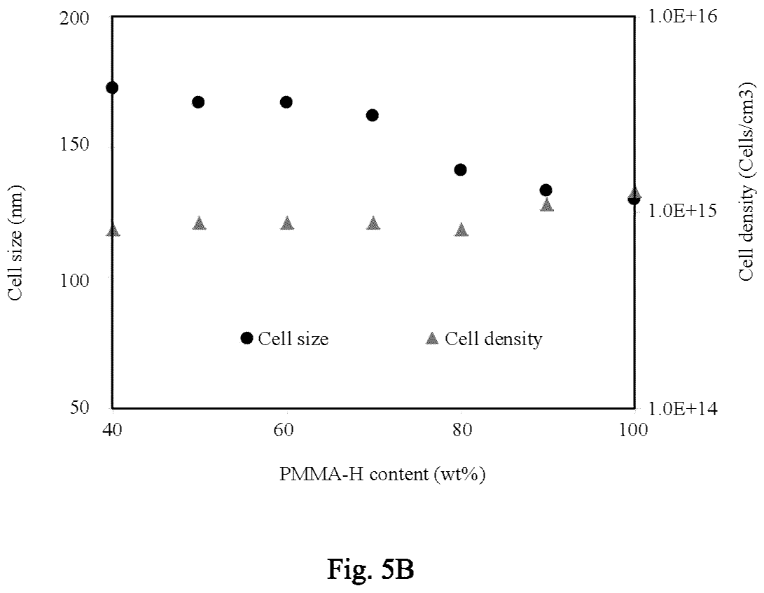

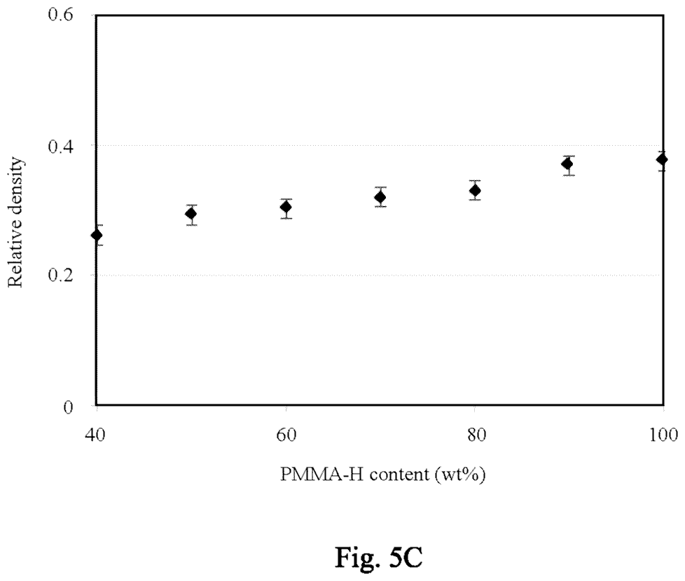

FIG. 5A shows images of polymeric nanofoams formed of PMMA-L, PMMA-H, and their blends respectively after being saturated at 31.03 MPa and 25° C. for 24 hours and then hot-press foamed at 80° C. The hot-press method solved the flatness issue of flat nanofoam, producing multiple flat samples of 100×70×7 mm³ size. The polymeric nanofoams obtained have a homogeneous nanocellular type.

FIG. 5B shows the cell size and cell density for nanofoams formed of different PMMA-H contents. As the PMMA-H content in the blend sheet increases, cell size decreases; the cell density of the formed polymeric nanofoams ranges from 10¹⁴ cells/cm³ to 10¹⁵ cells/cm³.

FIG. 5C shows and the relative densities for nanofoams formed of different PMMA-H contents. The relative density of each polymeric nanofoam is 0.26 to 0.38. It can be seen that as the PMMA content increases, the relative density increases. The results indicate that adding PMMA-H to the blend can control the cell size and the relative density of the nanofoam.

Blending PMMA with different molecular weights significantly changes the viscosity of the polymer. Since viscosity and melt strength are closely related, the change in viscosity may be the reason for different cell structure variations. As shown in FIGS. 5A to 5C, the cell structure variation of the PMMA-LH blends is a function of PMMA-H content. When the melt strength is increased, cell growth and coalescence may be suppressed, leading to a decrease in cell size and an increase in cell density. Furthermore, the results demonstrate that it is possible to prepare nanocellular foam with a cell size of less than 200 nm and of considerable thickness; therefore, the results demonstrate the potential for mass-scale production.

Furthermore, foaming using saturation condition I generates a homogeneous nanocellular structure. The homogeneity of the samples, defined as the ratio of the standard deviation to average cell size, foamed under Saturation Condition I ranged from 0.42 to 0.52. Thus, the structure can be considered as homogeneous.

The foam material produced under saturation condition I has a uniform nanocellular structure with a density between 0.23 and 0.37. The PMMA-LH50 foamed under saturation condition shows a relatively defect-free surface, a relative density below 0.3, and a cell size below 200 nm. However, in some embodiments, such high solid content may be less favorable for heat insulation as it may significantly increase the effect of solid heat transfer.

The cell structure of PMMA blends foamed with Saturation Condition II

One way to reduce the relative density is by introducing micron-sized cells (i.e., microcells) in the nanocellular foam. Micron-sized cells are introduced under lower temperature saturation conditions.

In a comparative example, the cell structure of a 4 mm thick PMMA-LH50 foamed in a thermal bath at 50° C. or 80° C. under saturation condition II-1 shows a microporous structure with an average cell size of about 40 μm and cracks, with a relative density of about 0.24.

In an experimental example, under saturation condition II-2, increasing Pₛₐₜ to 20.68 MPa to increase CO₂ concentration to about 36 wt % resulted in a bimodal cellular structure in the foam material. However, visible cracks also appeared in the foam sample. It can be seen that in addition to viscoelasticity, the saturation state also causes morphological changes.

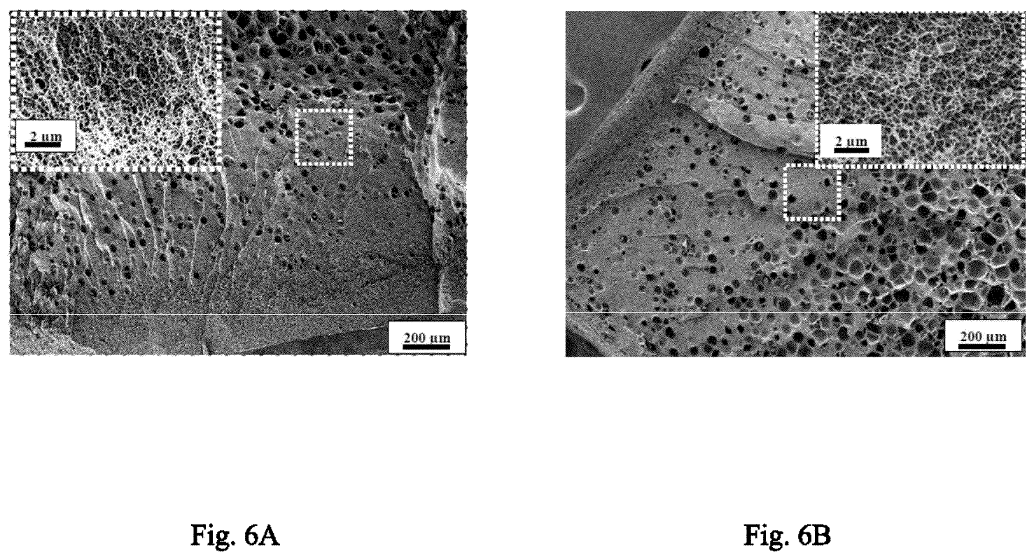

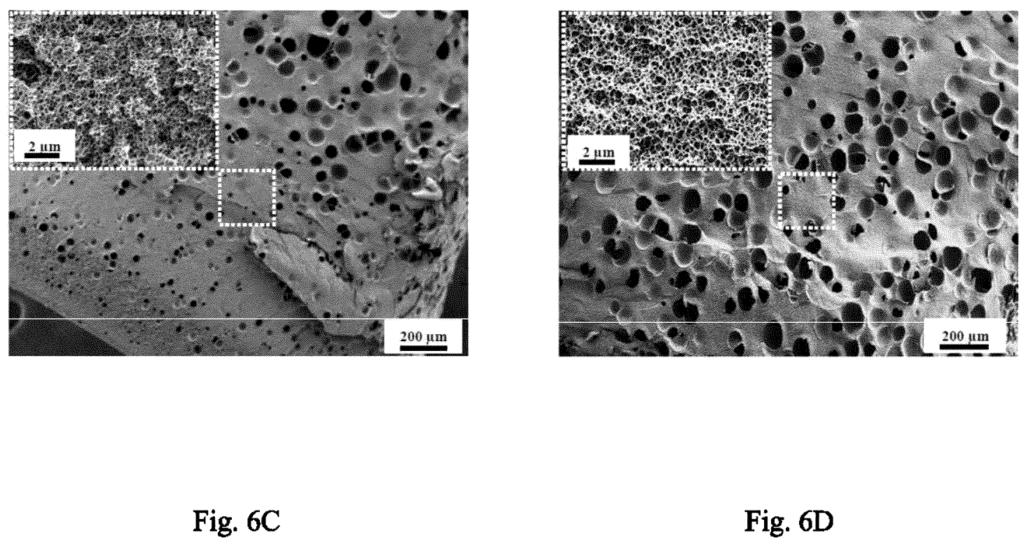

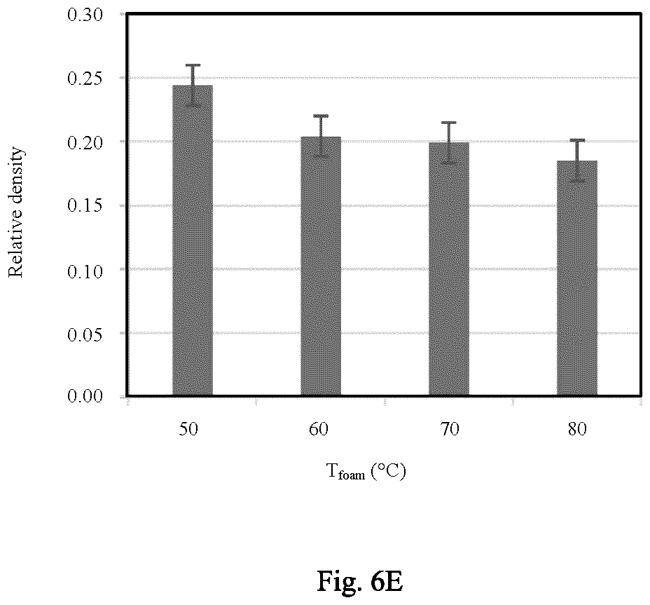

FIGS. 6A to 6D show PMMA-LH50 foamed under saturation condition II-2 and hot-pressed at 50° C., 60° C., 70° C., and 80° C., respectively. The figures show that the resulting foam material has a bimodal microcellular/nanocellular structure. FIG. 6E shows the relative density of foam materials obtained by hot-press foaming at different temperatures, indicating that the relative density decreases as the foaming temperature (T_{foam}) increases. The increase in microcell size may be the reason for the decrease in relative density of the foam material, as the PMMA-LH50 sample foamed at 80° C. shows a uniformly distributed cellular bimodal structure and lower relative density. Moreover, although not visible in the SEM images in FIGS. 6A to 6D, the samples in FIGS. 6A to 6D have cracks.

Cracking is not uncommon in low molecular weight PMMA nanocellular foam. It may be that if the polymer viscosity cannot withstand the high-pressure during foaming, cracks start to form. Therefore, increasing PMMA-H content may help reduce crack formation.

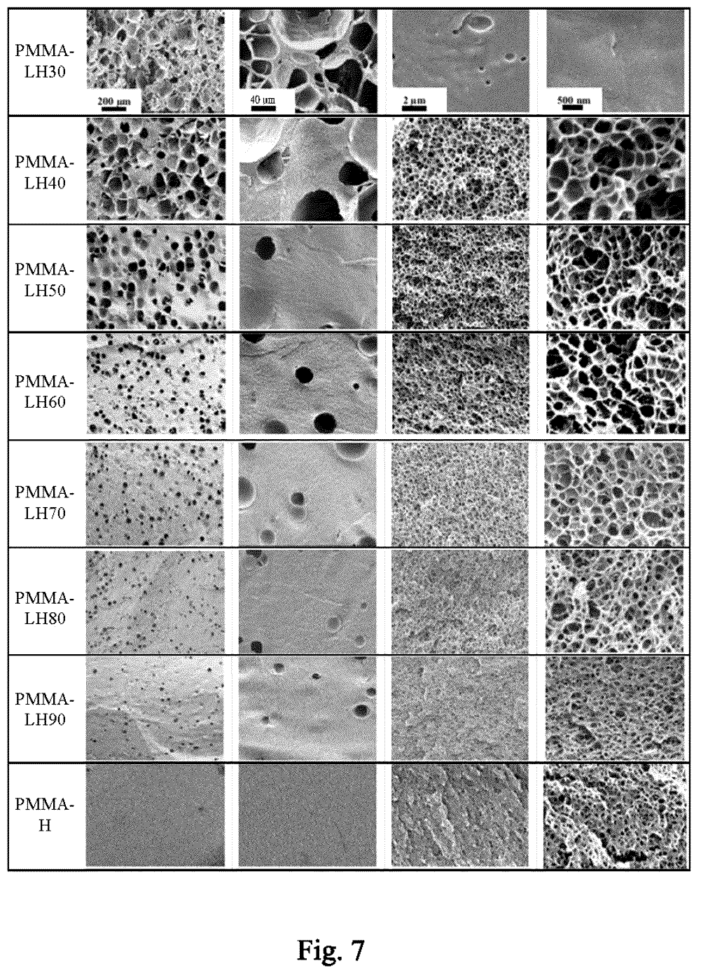

FIG. 7 shows the cellular structures of various PMMA-LH samples and PMMA-H samples foamed under saturation condition II-2 and hot-press foaming at 80° C. The results indicate that saturation at 0° C. and increasing CO₂ solubility to 36 wt % produces a bimodal cellular structure. When PMMA-H is less than 40 wt %, a microporous structure is obtained, and no nanocells are observed. As the PMMA-H content increases, the proportion of nanocells increases. Moreover, when the PMMA-H content exceeds 60 wt %, the cracks disappear.

As shown in FIG. 7 and Table 1 below, the cell size range in the bimodal cell structure of the foam material ranges from tens of nanometers to tens of micrometers. As shown in Table 1, as the PMMA-H content increases, the average cell size of all groups (nanocell, ultra-microcell, and microcell) decreases. PMMA-LH40 does not have cells smaller than 200 nm, while PMMA-LH90 has nanocells with an average cell size smaller than 100 nm. PMMA-H has a homogeneous cellular structure with an average cell size of 82 nm.

Table 1

| | average cell size | | | |
|---|---|---|---|---|
| | Nanocell | Ultra-microcell | Microcell | |
| | (<200 nm); | (200~1000 nm); | (>1 μm); | relative |
| sample | Unit(nm) | unit (nm) | unit (μm) | density |
| PMMA-LH40 | — | 562 | 68 | 0.175 |
| PMMA-LH50 | 117 | 277 | 43 | 0.185 |
| PMMA-LH60 | 121 | 273 | 38 | 0.197 |
| PMMA-LH70 | 121 | 242 | 31 | 0.240 |
| PMMA-LH80 | 115 | 250 | 25 | 0.330 |
| PMMA-LH90 | 91 | — | 24 | 0.369 |
| PMMA-H | 82 | — | — | 0.433 |

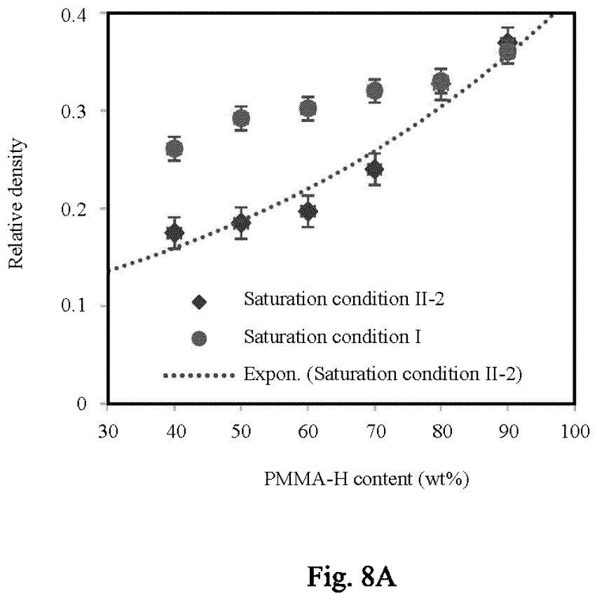

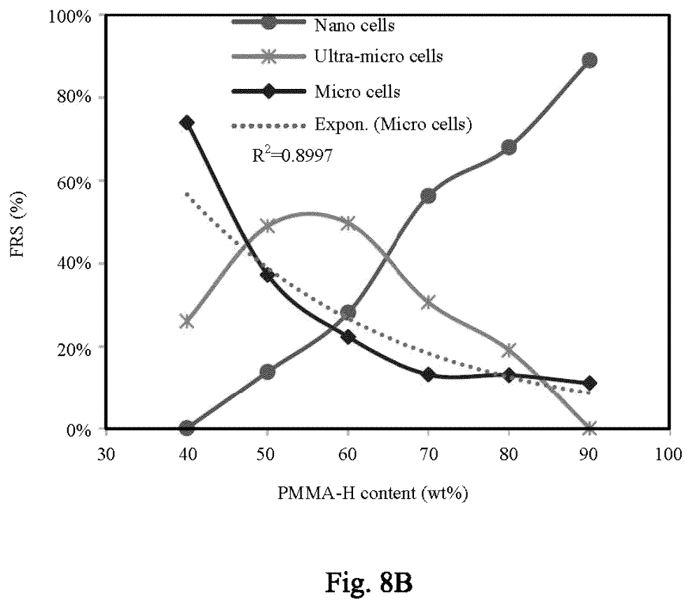

FIG. 8A shows the related density for foams formed of different PMMA-H contents, and the foams formed under saturation condition I and saturation condition II-2. FIG. 8A shows that the relative density of PMMA-LH blends formed under saturation condition II-2 is lower than that of samples foamed under saturation condition 1. As PMMA-H content increases, the relative density of samples with homogeneous nanocellular type (foamed under saturation condition 1) increases linearly, while the relative density of samples with bimodal cellular type (foamed under saturation condition II-2) increases exponentially. The trend line shown in FIG. 8A is based on exponential data fittings.

As shown in FIG. 7, as the PMMA-H content increases, the size and number of microcells decrease and are replaced by nanocells. The cell size distribution of the bimodal cellular structure affecting relative density is usually defined by the frequency relative to the surface (FRS). FRS reflects the area contribution of cells in bimodal or multimodal foamed materials.

In some embodiments, FRS is calculated using the above formula 1 based on the SEM images of the foam material. Furthermore, since the SEM images cannot cover all cell sizes ranging from tens of nanometers to tens of micrometers, when the foam material contains micron-sized cells, the following formula 4 is used for calculation:

$${N}_{100 \times } = \frac{{N}_{50000 \times } ( {A}_{100 \times } - {A}_{m} )}{{A}_{50000 \times }} \qquad ( 4 )$$

where N_{100×} and N_{50000×} are the numbers of the corresponding cells in the 100× and 50000×SEM pictures, respectively. A_{100×} and A_{50000×} are the areas of the 100× and 50000×SEM pictures, and Aₘ is the area occupied by the micron-sized cells in the 100×SEM picture.

FIG. 8B shows the FRSs of the cell groups (nanocells ultra-microcells, and the microcells) for the nanofoams formed of different PMMA-H contents. Moreover, the exponential fitting results show that the FRS of the microcells decreases exponentially with increasing PMMA-H. The decrease may be related to the exponential increase in relative density, since FRS is determined based on a two-dimensional microscopic picture and the relative density is based on the three-dimensional volume measurement. The results support the hypothesis that the two-dimensional microstructural information can be used to infer the three-dimensional cell structure. Further, controlling the fraction of the microcells may influence the relative density of the bimodal foam.

Previous studies have not sufficiently investigated the thermal conductivity of foams having cell sizes below 200 nm. In the experimental examples of the present disclosure, the thermal properties of the polymeric namofoam obtained by the steady-state method are shown in Table 2 below. Table 2 shows the thermal conductivity of the homogeneous nanocellular foams (prepared under saturation condition 1) and bimodal cellular foams (prepared under saturation condition II-1) in the experimental examples, with cell sizes ranging from 128 nm to 25 μm and relative densities ranging from 0.23 to 0.33.

TABLE 2
Thermal Conductivity (λₜ) of
Nanocellular Foam and Bimodal Foam

| | | | | | FRS of nano/ | |
|---|---|---|---|---|---|---|
| | | | average cell | | ultra-micron/ | λₜ |
| Sample | Cellular | relative | size | | micron cells | at 12.5° C. |
| No. | structure | density | nm | μm | (%) | (mW/mK) |
| 1 | Microcells | 0.238 | — | 1.58 | 0/0/100 | 49.42 |
| 2 | Nanocells | 0.234 | 480 | — | 0/100/0 | 43.65 |
| 3 | Nanocells | 0.290 | 182 | — | 25/75/0 | 42.13 |
| 4 | Nanocells | 0.330 | 141 | — | 100/0/0 | 45.53 |
| 5 | bimodal | 0.245 | 137 | 31 | 56/31/13 | 44.12 |
| | cells | | | | | |
| 6 | bimodal | 0.330 | 128 | 25 | 68/19/13 | 49.72 |
| | cells | | | | | |

According to the embodiments of the present disclosure, PMMA pellets of different molecular weights can be mixed to control the cell structure. Furthermore, by controlling the saturation conditions, the morphology of the foam can be adjusted to homogeneous nanocells or bimodal cellular structures. For example, at 31.03 MPa and 25° C. (saturation condition I), homogeneous nanocellular foams with a cell size of 130 nm to 200 nm and a relative density of 0.23 to 0.38 were produced. By changing the saturation conditions to 0° C. and 20.68 MPa (saturation condition II-2), bimodal cellular structures were produced using the same blends. In some embodiments, the relative density of the bimodal cellular foam was reduced to 0.19.

Embodiments of the present disclosure disclose that flat, large-sized, smooth polymeric nanofoam with considerable thickness can be produced by hot-press foaming, and the fabrication parameters can be tuned to produce nanofoam having lower relative density and lower thermal conductivity.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A polymeric nanofoam comprising:
a plurality of nanocells, wherein an average diameter of the plurality of nanocells is less than 200 nm, and a number of the plurality of nanocells is higher than 10¹³ cells/cm³;
wherein the polymeric nanofoam is formed of polymethyl methacrylate (PMMA), having a flat area greater than about 50 cm², a thickness greater than 5 mm, and a relative density less than 0.5.

2. The polymeric nanofoam of claim 1, wherein a maximum deviation from the flat area is less than 1000 μm.

3. The polymeric nanofoam of claim 1, wherein the flat area is smooth, and average height deviations from a mean line of the flat area is less than 500 μm.

4. The polymeric nanofoam of claim 1, wherein the polymeric nanofoam is a homogeneous nanocellular type, and the relative density of the polymeric nanofoam ranges from about 0.23 to about 0.44.

5. The polymeric nanofoam of claim 4, wherein the number of the plurality of nanocells is higher than 10¹⁴ cells/cm³.

6. The polymeric nanofoam of claim 4, wherein a coefficient of variation (CV) in size of the plurality of nanocells is less than 0.52.

7. The polymeric nanofoam of claim 1, further comprising:
a plurality of microcells, wherein diameters of the plurality of microcells range from 1 μm to 100 μm;
wherein the polymeric nanofoam is a bimodal cellular type, and the relative density of the polymeric nanofoam ranges from about 0.18 to about 0.4.

8. The polymeric nanofoam of claim 7, wherein a frequency relative to a surface (FRS) of the plurality of microcells ranges from about 10% to about 45%.

9. The polymeric nanofoam of claim 1, further comprising:
a plurality of ultra-microcells, wherein diameters of the plurality of ultra-microcells range from 200 nm to 1 μm.

10. A method for fabricating a polymeric nanofoam, comprising:
saturating a polymethyl methacrylate (PMMA) sheet with CO₂ to form a PMMA/gas mixture, wherein a CO₂ content in the PMMA/gas mixture is greater than 25 wt %, and a weight of the PMMA sheet is 100 wt %;
performing a depressurization on the PMMA/gas mixture;
transferring the PMMA/gas mixture to a hot-press foaming machine; and
foaming the PMMA/gas mixture at a temperature of 50° C. to 80° C. to form a polymeric nanofoam board, wherein the PMMA/gas mixture is sandwiched between two porous metal plates, and the polymeric nanofoam board has a plurality of nanocells, a flat area greater than 50 cm², a thickness greater than 5 mm, and a relative density less than 0.5.

11. The method for fabricating the polymeric nanofoam of claim 10, wherein a cellular structure type of the polymeric nanofoam board is controlled by adjusting saturation conditions of the PMMA/gas mixture or rheological properties of the PMMA sheet, and the cellular structure type is associated with a thermal conductivity of the polymeric nanofoam board.

12. The method for fabricating the polymeric nanofoam of claim 10, wherein a viscosity at 1.25 s-1 shear rate of the PMMA sheet ranges from about 1×10⁴ Pa·s to 1×10⁵ Pa·s.

13. The method for fabricating the polymeric nanofoam of claim 10, wherein the saturating a PMMA sheet with CO₂ to form the PMMA/gas mixture is performed under a first saturation condition, and the first saturation condition comprises a first temperature ranging from 24° C. to 26° C. and a first saturation pressure ranging from 30 MPa to 32 MPa.

14. The method for fabricating the polymeric nanofoam of claim 13, wherein the first saturation condition is performed for at least 18 hours.

15. The method for fabricating the polymeric nanofoam of claim 10, wherein the saturating a PMMA sheet with CO₂ to form the PMMA/gas mixture is performed under a second saturation condition, and the second saturation condition comprises a second temperature ranging from 0° C. to 2° C. and a second saturation pressure ranging from 19 MPa to 22 MPa.

16. The method for fabricating the polymeric nanofoam of claim 15, wherein the second saturation condition is performed for at least 36 hours.
